(19) United States
(12) Patent Application Publication
(10) Pub. No.: US 2008/0039957 A1
(43) Pub. Date: Feb. 14, 2008

(54) Signal Processing Methods And Apparatus

(75) Inventor: Reza Hoseinnezhad, Hawthorn (AU)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Rabit Joint Venture Limited, East Bentleigh (AU)

(21) Appl. No.: 11/630,064

(22) PCT Filed: Jun. 21, 2005
(86) PCT No.: PCT/AU05/00888

§ 371 Date: Jul. 24, 2007

(30) Foreign Application Priority Data
Jun. 22, 2004 (AU) 2004903397

(51) Int. Cl. G05B 13/02

(52) U.S. Cl. 700/44; 701/1

(57) ABSTRACT

A control system, such as a vehicle management system, having a processing unit (20) and a sensor for providing data samples (22), includes a multi-step ahead predictive filter that predicts data samples based on a weighted function of prior data samples (26). This allows the system to continue to function using predicted data samples, when for example the receipt of actual data samples (22) is temporarily interrupted, e.g. due to noise, a communications fault or the like. The filter uses a single set of weights (28) for weighting the prior data samples (26), irrespective of the number of missing data samples for which the prediction is required, and the set of weights (28) is determined based on the characteristics of the sensor signal. Various methods for determining the set of weights are also disclosed.

The present invention claims priority from Australian Patent Application No. 2004903397 filed on 22 Jun. 2005 and entitled “Signal Processing Methods and Apparatus”, the contents of which are incorporated herein in their entirety by reference.

The present invention relates to signal processing methods and apparatus that provide multi-step ahead predictive filtering of data. It also relates to control systems that implement multi-step ahead predictive filtering, including vehicle management systems that use multi-step ahead predictive filters.

Typically, a control system includes a control unit that can operate one or more actuators, and a sensor or sensors that can provide data on the state of the system. The control unit uses the sensor data to make control decisions and to operate the actuators based on the system state.

Control systems often provide safeguards against sensor malfunction, e.g. by providing redundant sensors and/or a failsafe condition. Besides a complete sensor loss, control systems may also suffer intermittent data loss. For example, sensor data can sometimes fail to reach a control unit. This may happen for a number of reasons, and may be due to a temporary problem with the sensor itself and/or with the data transmission path. It may for example result from an instantaneous short circuit or disconnection, a communications network fault and/or a sudden increase in noise.

In order to address the problem of intermittent data loss, it is known to provide predictive filters, which attempt to predict sensor data from previously received real sensor data. Thus, when real data is absent for one or more sensor sample steps, the control unit uses a predictive filter to determine what the missing data should have been (based on a number of the previous real data samples).

The present invention aims to provide novel methods and apparatus for predicting data when actual sensor data is missing.

Viewed from one aspect, the present invention provides a control system having a processing unit and a sensor, the system including a multi-step ahead predictive filter for the sensor data, the filter predicting a data sample based on a weighted function of prior data samples, wherein the filter uses a single set of weights for weighting the prior data samples, irrespective of the number of missing data samples for which the prediction is required, and wherein the set of weights has been previously determined based on the characteristics of the sensor signal.

From one aspect, the present invention can be seen as a type of finite impulse response (FIR) filter. In prior predictive FIR filter systems, however, a number of different filters must be applied, each with their own set of weights, as the filter must change depending on how many consecutive missing data samples have to be handled by prediction, e.g. whether the system needs to look one, two, three or more data steps ahead from the last real data sample. Thus, in the prior art filters, the filter weights are determined based on the number of steps ahead for which data must be predicted: If data is only missed over one time period, then one set of coefficients would be appropriate, if data is missed over two consecutive time periods, then another set of coefficients would be needed, and if data were to be missed over three sample intervals, then a still further set of coefficients would be required. The ability to determine four or more sample steps ahead would entail a corresponding increase in the number of sets of weights.

In contrast, the present invention uses only a single set of weights, no matter the number of steps ahead for which data must be predicted. This saves memory, as only one set of weights must be stored. It also saves on computational time, as there is no need to lose valuable processing time in selecting an appropriate set of weights for the sample being predicted. The present system is therefore particularly applicable to applications that are time and/or memory critical and in which real time predictive filtering is required.

The present invention approaches the construction of predictive filters from a system-specific perspective rather than from the perspective of how many steps ahead the data has to be predicted. Thus, in the present approach, a single set of weights is determined based on the particular dynamics of the output sensor signal that the filter is to be used with. This contrasts with the prior art, in which the weights are not functions of the sensor characteristics. In the prior art, the predictive filters and their weights have more universal application, whereas in the present invention, a set of weights is applicable to a particular sensor or sensor type. Thus, in the present invention, generality is sacrificed for low memory and/or computational time overheads. The present invention may also provide a higher performance prediction.

The control system may include for example a vehicle management/control system. In these systems, vehicle state and driver indications are sampled and processed at a high rate, whilst the amount of memory available for storing data is limited. The present invention can in one embodiment provide an excellent way to provide predictive filtering faced with these limitations. The data sampled could include for example vehicle states, such as wheel speeds, yaw, and the like, and driver indications, such as brake depression, throttle depression, steering angle and the like.

The present invention assumes that the sensor dynamics will not change dramatically over time, and, indeed, this will usually be the case. Thus, generally a sensor will either remain stable over time or will fail catastrophically. In the latter case, an alternative control policy must be put in place, e.g. the provision of a redundant sensor and/or the triggering of a failsafe condition, such as shutdown. This may occur for example when it is determined that more than a set number of data samples have been missed.

In one embodiment, the system is configured so that the weights are updateable, e.g. they may be provided on flash memory. This would allow the weights to be updated at regular intervals, and would allow the weights to be modified based on gradual changes in the sensor over time, should this be necessary. Such an update could for example occur during the normal servicing of a vehicle or the like.

In accordance with an embodiment of the present invention, a one-step ahead data sample is predicted as a linear combination of a number (P) of previously received actual data samples. These P data samples are temporarily stored in memory, with each new data sample received being placed in memory, and the oldest data sample accordingly being discarded. When a one-step ahead data sample must be predicted due to a missing sample, that predicted data sample is stored as the newest data sample, and when a two-step ahead data sample must be predicted, it is a linear combination of the recently predicted data sample and the previous P−1 physical data samples.

The filter may take the form

$$\hat{y} ( k ) = {\sum }_{i = 1}^{P} {a}_{i} {y}^{′} ( k - i ) \qquad ( 1 )$$

where y′(k−i) is either equal to a previous data sample y(k−i) or a previously predicted sample ŷ(k−i).

In order to determine the weights of a filter for a sensor, a training procedure may be used in which known training data from an output for the sensor of interest is applied to a filter, and in which the filter coefficients are iterated to provide an optimised error function.

This training procedure may be carried out by the processing unit itself at an appropriate time, or may be conducted by an external processor with added memory capacity and the like. The external processor could for example plug into the control system to receive the sensor signal of interest. Alternatively, the sensor signal could be modelled/simulated externally to the system, e.g. by using an identical sensor system, i.e. an identical sensor and identical monitored subject.

In one embodiment, where predictions are required for up to L possible missing data pieces and where N pieces of training data are used, the error function may take the form of a sum of L terms, one for each possible step ahead prediction, each term being a sum of errors over all N pieces of data between the actual data value and the predicted error for that term's step ahead. Thus, the error function may be of the form:

$$E = \frac{1}{2} {\sum }_{j = 1}^{L} \{ {\sum }_{k = 1}^{N} {[ y ( k ) - {y}_{j} ( k ) ]}^{2} \} \qquad ( 2 )$$

Minimisation of this error function provides a set of weights that can be applied to any of the 1 to L step ahead predictions for the sensor in relation to which the training has been performed.

In one embodiment, the terms of the error function may be weighted to prioritise one or more of the multi-step ahead predictions:

$$E = \frac{1}{2} {\sum }_{j = 1}^{L} \{ {C}_{j} {\sum }_{k = 1}^{N} {[ y ( k ) - {y}_{j} ( k ) ]}^{2} \} \qquad ( 3 )$$

Thus, if the sensor system is such that missing data generally occurs in a sequence of three samples, then the error function may be weighted so that the three-step ahead term C₃ has a higher weighting, and so will dominate in the determination of the weights. In this case, the resulting weights will provide the best prediction for three-step ahead predictions.

In one embodiment, the error function is weighted so that the first step ahead prediction has a higher weighting than the second, and so on, C₁>C₂> . . . C_{L}, as it will often be the case that missing data will occur most often as a single piece of missing data, and the larger the number of consecutive pieces of missing data, the less likely the situation is to occur.

The error function may take any other suitable form, i.e. one that reflects the goodness of the prediction as a function of the multi-step ahead predictions. It may be generalised as:

$$E = {\sum }_{j = 1}^{L} {C}_{j} \{ {\sum }_{k = 1}^{N} ρ ( {y}_{j} ( k ) - y ( k ) ) \} \qquad ( 4 )$$

where ρ(x) is any function with the following properties: 1) ρ(0)=0, 2) for all x, ρ(x)≧0, and 3) if |x₁|>|x₂| then ρ(|x₁|)>ρ(|x₂|). Thus, in equations (2) and (3) above, we have ρ(x)=1/2 x².

The iteration may take any suitable form, and, in one embodiment, the error function is optimised using a steepest gradient method. In this embodiment, the gradient of the error function with respect to the weight vector of the coefficients is determined, and the weight vector is moved downwardly along the gradient.

A momentum term may be included in the determination of the weight vector iteration, so as to avoid the iteration becoming trapped in a local minimum.

Iteration may be initialised by a zero order hold filter, i.e. all but the first of the filter weights may initially be set to zero. If re-tuning, the iteration may begin with the current set of coefficients.

Once the error function is optimised, the resulting weights are used as the filter weights for the sensor under consideration. These coefficients are then used in normal real time processing to predict missing data during operation of the control system.

Other optimisation algorithms are also possible. Thus, the problem is to search for the absolute minimum of the error or cost function (2) or (3), and is an optimisation problem. Other optimisation search algorithms might include e.g. dynamic programming, genetic algorithms, and evolutionary computer algorithms.

The iterated weights may continue to be used assuming the dynamics of the sensor signal remain stable. If however the sensor signal dynamics change for some reason, the weights may need to be re-tuned. As said above, this may be achieved by re-testing and re-determining the weights during a routine servicing of the equipment. It could also be carried out adaptively in real time. In one embodiment, the processing unit may include a routine to tune the weights, e.g. at a time when the sensor is not being used in the control process. Alternatively, weight tuning may be conducted by an external processor that either plugs into the system or is part of a simulation with e.g. an identical sensor system.

The number of training data samples N used may vary depending on the dynamics of the sensor signal. It may also depend on the application where it is used. For example, if the sensor is a displacement or force sensor in a brake pedal, the N training data samples should include sensor signals for all possible braking states, including for example brake release, soft and graduated braking, hard and sudden braking, and the like. Thus, preferably, the training data simulates all major types of system state that may occur in the system which the sensor is to monitor.

The number of multi-step ahead predictions L modelled may also vary. Generally, L is the maximum number of consecutive missing data samples that can be tolerated by the system to which the predictive filter is to be applied. More than L missing consecutive data samples in the system would then require an alternative policy, such as ignoring the data, using redundant sensors and/or entering a failsafe condition such as shutdown.

The higher the number of weights and previous data samples used, the better the prediction will generally be, although this will result in more memory being used and more processor time to determine the prediction.

The present invention may be used in many different types of control system. The connection between the sensor and processing unit may take any suitable form, and could be for example a direct connection or a connection along a communications bus or other network, be it cable or wireless. The processing unit may receive discrete samples of data from the sensor, or may receive a continuous signal that the processing unit then samples. In either case, if the sensor signal is missing or corrupt, so that no data sample can be obtained, the predictive filter can be used to provide the missing data.

The detection of a missing data sample may take any suitable form. For example, the control unit may determine that no communication has been received from the sensor, or that the data/signal received is outside of a normal data range for the sensor, or that the data has been corrupted, e.g. through the processing of an error detection algorithm, e.g. a checksum digit or the like.

As said, the present control system may be used in vehicle control. It may also be used in other fields. It may be used for example in systems in which one or more sensors play a vital role in the system, and in systems in which missing sensor data may cause system failure and/or may raise safety critical issues. This would apply for example to brake systems in general. Other examples could include aerospace control systems, military control systems, satellite motion control systems, and space robotic control systems, especially those that are mainly controlled autonomously by their own sensors. It could for example relate to systems in which the sensor data stream is GPS data. It is particularly useful in applications that have restrictive amounts of memory and/or processor time available.

The present invention extends to a method of signal processing using the above-discussed predictive filter. Thus, viewed from another aspect, the present invention provides a method of controlling a sensor system, including the step of predicting sensor data, the method including the step of predicting a data sample based on a weighted function of prior data samples, wherein a single set of weights are used to weight the prediction function for predictions for a plurality of different numbers of consecutive missing data samples, and wherein the set of weights has been previously determined based on the characteristics of the sensor output.

The present invention also extends to a method of tuning the weights of a predictive filter as discussed above. Thus, viewed from another aspect, the present invention provides a method of determining the weights of a multi-step ahead predictive filter for a sensor, the method including the step of determining a single set of weights for a plurality of the predictions, wherein the set of weights are determined based on the characteristics of the output of the sensor.

The present invention further extends to computer software for implementing the present invention. Thus, viewed from a further aspect, the present invention provides computer software for controlling a system based on data from a sensor, the software including:

a component for detecting that sensor data is unavailable; and

a component for estimating the sensor data when unavailable, the sensor data being estimated based on a weighted function of prior data samples, wherein a single set of weights are used to weigh the prior data samples for all estimates, and wherein the weights are based on the characteristics of the sensor output.

The computer software may be provided on any suitable computer readable storage media, and the present invention extends to a computer readable storage media having the computer software therein. It also extends to hardware and firmware in which the software code is embedded.

The present invention further extends to a method of servicing a control system according to the invention, in which the filter weights are tested and re-tuned in accordance with any changes in the dynamic characteristics of the sensor signal.

The present invention is particularly applicable to vehicle control systems, and from another aspect provides a vehicle control system including a control unit and a sensor, the system including a multi-step ahead predictive filter for the sensor data, the filter predicting a data sample based on a weighted function of prior data samples, wherein the filter uses a single set of weights for weighting the prior data samples, irrespective of the number of missing data samples for which the prediction is required, and wherein the set of weights has been previously determined based on the characteristics of the sensor signal.

Viewed from a further aspect, the present invention provides a control system including a control unit and a sensor, wherein the system includes a predictive filter for determining missing sensor data, the filter taking the form:

$$\hat{y} ( k ) = {\sum }_{i = 1}^{P} {a}_{i} {y}^{′} ( k - i )$$

where y′(k−i) is either equal to a previous data sample y(k−i) or a previously predicted sample ŷ(k−i), and wherein the aᵢ are determined based on characteristics of the sensor signal, such that the same set of aᵢ are used for all missing data predictions.

It should be noted that any one of the aspects mentioned above may include any of the features mentioned in relation to any of the other aspects mentioned above, as appropriate.

Embodiments of the present invention will now be described, by way of example only, with reference to the accompanying drawings. It is to be understood that the particularity of the drawings does not supersede the generality of the preceding description of the invention.

In the drawings:

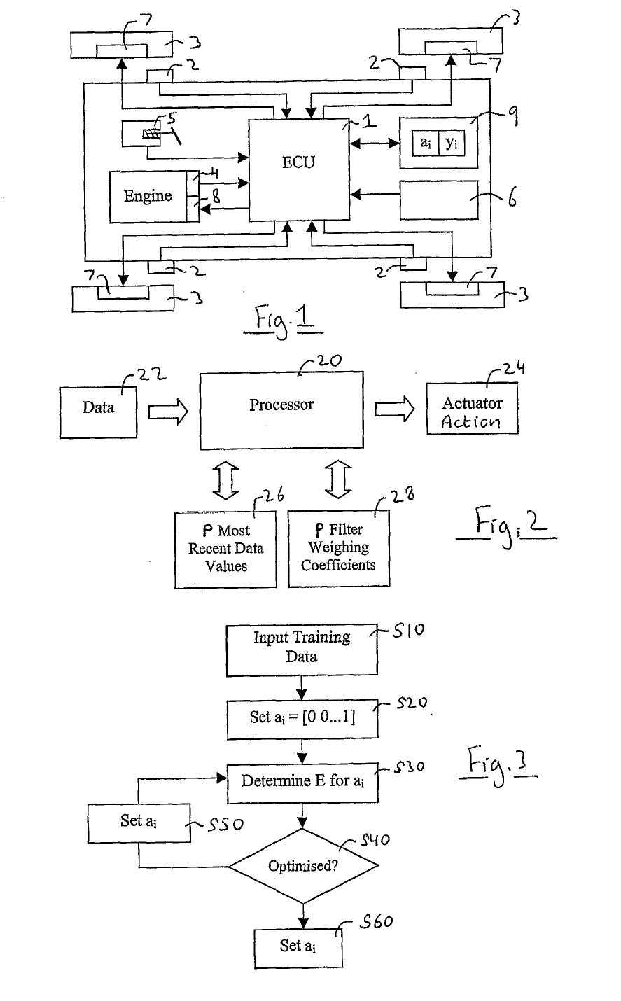

FIG. 1 is a schematic diagram of a vehicle control system incorporating a predictive filter in accordance with an embodiment of the present invention;

FIG. 2 is a schematic block diagram of a general control system incorporating a predictive filter in accordance with an embodiment of the present invention; and

FIG. 3 is a flowchart relating to a training method for determining an optimum set of weights for a predictive filter according to an embodiment of the present invention.

Referring to FIG. 1, a vehicle management system is shown in schematic form. The management system includes an electronic control unit (processing unit) 1 that receives signals from various sensors relating to the vehicle state and to the driver's intensions, and that outputs signals to various actuators to control the operation of the vehicle.

The vehicle sensors may include wheel speed sensors 2 for determining the rotational speed of the vehicle wheels 3, and engine sensors 4 for determining e.g. temperatures and the like.

The driver indicator sensors may include for example a brake pedal sensor 5 that provides a signal proportional to the driver's demand for braking, e.g. as determined by the amount of movement of the pedal or the force exerted by the driver's foot on the pedal.

Other driver demand sensors (human machine interaction (HMI) sensors) and vehicle and engine state sensors may also be included, and are generally labelled 6. They may include for example yaw sensors, exhaust gas sensors, such as NOX and O₂ sensors, a steering angle sensor based on the driver's turning of the steering wheel, and a sensor for a driver's throttle pedal. Various other by-wire control sensors could also be included, e.g. possible brake by-wire sensors could include clamp force sensors, current sensors (which measure the current of electric motors in brake callipers), and rotor encoders (which measure the angular displacement of the rotor of the motors).

The control unit 1 analyses the data from the sensors, and performs various vehicle management functions based on the data by applying control signals to various actuators.

These actuators may include for example brake actuators 7 on the wheels 3, and may also include for example engine controls actuators 8, such as fuel injectors, spark igniters, exhaust feedback controls and the like.

The control unit 1 may control the vehicle in a number of different manners. These may include for example anti-lock braking systems (ABS), traction control (TC), vehicle stability, cruise control functions, and panic braking controls. They may also include general engine management, e.g. timing and fuel injection amounts, for optimal fuel efficiency, acceleration or the like. The control unit 1 may also control normal driving functions, e.g. in a by-wire vehicle control manner, so that a driver's demand, e.g. a desire to increase speed or to brake or the like, is noted by the control unit, which can then implement the necessary commands to effect the desired action.

The control unit 1, the sensors 2,4,5, 6, and the actuators 7,8 may communicate in any suitable manner. They may be individually connected together, and/or may connect together via one or more communications buses.

In accordance with an embodiment of the present invention, should the control unit 1 fail to receive a data sample from one or more of the various sensors, e.g. from a wheel sensors 2 or the brake sensor 5, the control unit 1 implements a multi-step ahead predictive filter for predicting these missing data samples based on prior data samples. This ensures that proper control of the vehicle is maintained, even when sensor data is missing, e.g. due to a temporary short-circuit or disconnection or a spike in a noise level.

The control unit 1 has an associated memory 9 in which it stores the last P data samples y(k−i) (i=1 to P) received from a sensor at sampling times (k−1)Tₛ to (k−P)Tₛ, where k is the current sample number and Tₛ is the sampling time. Thus, once a new data sample is received, the oldest stored data record is discarded, each of the currently stored data values is moved backwards one memory unit to become data piece y(k−(i+1)), and the new data sample is recorded at data location y(k−1).

When a single data sample is missing, then the predictive filter will use the previous P data samples that have been stored to provide a one-step ahead prediction. The filter is based upon an FIR filter using a set of P weights aᵢ (i=1 to P) that are also stored in the memory 9 and that have been previously determined for the sensor in a training process discussed below. There is one coefficient aᵢ for each of the stored previous data samples y(k−i), and the predicted data sample is therefore a weighted linear combination of the previous P real data samples.

Once the missing data sample is predicted, it is treated as a real data value and used in the vehicle control process. It is also stored in the memory 9 as the newest of the data samples, and no distinction is made between this predicted data sample and data samples that are actually received from the sensor.

If two consecutive data samples are missed, then, on detecting the first missing piece of data, the predictive filter will use the same procedure as above to provide a predicted data sample corresponding to the first piece of missing data. When it detects the second piece of missing data, it will then repeat the process to provide a predicted data sample corresponding to the second piece of missing data. In this case, however, the second predicted data sample is a weighted linear combination of the first predicted data sample and the P−1 real data samples received previously to the first missing data sample.

This procedure is repeated appropriately for three, four, five or more (up to L) missing data samples. It will be noted that the system does not need to know how many data samples have been missed, as it will always repeat the same procedure. The processor 1 does not need to use valuable computation time in determining the number of missing data pieces and the appropriate filter. It may still count the number of times that data is missed, e.g. so that when over a set number of consecutive data points are missed, the sensor may be determined to be malfunctioning, and the processor 1 may then switch to an alternative regime, in which data from different sensors are used as a replacement or a failsafe condition is entered.

The determination of missed data may take any form, and for example may be determined by a lack of a signal from the sensor during a certain time period or the receipt of bad data. Bad data may for example be a data value that is not in accord with normal operating parameters, e.g. is too high or too low a voltage or the like. The data may also be determined as bad through an error check procedure, e.g. a checksum or the like.

The data may be digital data received from a sensor, or analogue data that the processor itself can then sample.

A feature of the present invention is that the same weights {a₁, . . . ,a_{P}} are used for all of the multi-step ahead predictions. This contrasts with known FIR filters, in which the weights as are functions of the number of steps ahead that the data sample is to be predicted, i.e. the weights aᵢ will depend on the number of data samples missing.

As the present invention is able to use only a single set of weights, memory space is saved. Computational time is also reduced, as the control unit 1 does not need to determine which of the filter weights is required for any particular piece of missing data. These attributes are especially useful in vehicle/engine management systems, where the available memory is limited, and computational time overheads are important.

In order to determine a suitable set of weights aᵢ, that can be used for all multi-step ahead predictions, the weights aᵢ are optimised based on the particular dynamic characteristics of a sensor signal. Thus, a particular set of weights coefficients {a₁, . . . ,a_{P}} is chosen for the brake pedal sensor 6, based on the dynamic characteristics of that sensor's output, and a different set of coefficients will be chosen for a wheel sensor 2.

In order to determine the weights for a sensor, a set of known training data for a sensor is used to tune the associated sensor filter. Thus, N pieces of known data samples are feed into the filter, and the weights aᵢ are iterated so as to optimise an error function between the actual data and the predicted data. The coefficients providing the optimum result are then used as the real-time calculation coefficients. A form for the error function and the iteration method is discussed more fully below.

It will be appreciated that the sensor signal dynamics may depend both on the characteristics of the sensor itself and on the characteristics of the object/feature being sensed. Thus, a rotation speed sensor may have one signal dynamic when used as a wheel speed sensor 2 to monitor a wheel's rotation, and may have a different signal dynamic if used to monitor rotation of a cam shaft or the like. Therefore, although the same sensor may be used in each situation, different filter weights will be needed. Where the sensor and the monitored item are the same, the same weights may be used, e.g. the same weights may be used for all four of the wheel speed sensors. It may however be the case that the wheels driven directly by the engine, e.g. the rear wheels or the front wheels, may have a different signal dynamic from the non-driven follower wheels, in which case separate sets of weights may be required. Also, it may be that sensors of the same type may have different characteristics due to tolerances in manufacture or wear over time and the like, in which case the same sensor types used to monitor the same features may require different weights.

Generally, the sensor characteristics will remain stable over time, and so, once the weights are initially determined, the filter will continue to provide good results during its lifetime. If changes in the characteristics of a sensor do occur, however, e.g. with age and wear, then new weights may be determined. These changes may e.g. be compensated for by re-tuning the weights at suitable times, e.g. during the normal servicing of a vehicle. Re-tuning may be carried out by an external device that may plug into the system, or could be carried out by the processor itself. The control unit 1 may be programmed to re-tune the weights during use, e.g. during times where the sensor output is not required and the control unit has spare computational time available.

The theory behind the present filter process is now discussed.

Where a processing unit receives data samples from a sensor, e.g. via a network, some of the data samples may be missed, e.g. due to instantaneous short circuits, network faults, and the like. The processing unit should replace the missing samples with predicted values. It is assumed that maximally L consecutive missing data samples are handled. If more than L consecutive samples are missing, then the processing unit may switch to another control policy, e.g. one in which the control command is based on other available sensory data or on redundant sensors or the like or where the system goes into a failsafe state until the problem is resolved.

Based on the number of recently missed samples, a missing sample is handled by a one-step ahead, a two-step ahead, . . . or an L-step ahead prediction. The predicted value of each missing sample is a linear combination of the most recent P data values, as follows:

$$\hat{y} ( k ) = {\sum }_{i = 1}^{P} {a}_{i} {y}^{′} ( k - i ) \qquad ( 5 )$$

where y′(k−i) is either equal to the previous data sample y(k−i) or the previously predicted sample ŷ(k−i). Because of the available limitations in memory, complexity and code execution delay, it is not desired to search for different aᵢ weights for one-step ahead, two-step ahead, . . . and L-step ahead prediction. Hence, the filter is tuned to use the same aᵢ values for prediction in all cases.

In the case of a one-step ahead prediction, the first missing sample is estimated by a linear combination of the P previous real samples, as follows:

$${y}_{1} ( k ) = {\sum }_{i = 1}^{P} {a}_{i} y ( k - i ) \qquad ( 6 )$$

In the case of a two-step ahead prediction, a second missing sample is estimated by the same linear combination of the recently predicted sample and the P−1 previous data samples, as follows:

$${y}_{2} ( k ) = {a}_{1} {y}_{1} ( k - 1 ) + {\sum }_{i = 2}^{P} {a}_{i} y ( k - i ) \qquad ( 7 )$$

Replacing y₁(k−1) from (6) in (7) results in the following equation:

$${y}_{2} ( k ) = {a}_{1} {a}_{P} y ( k - P - 1 ) + {\sum }_{i = 2}^{P} ( {a}_{1} {a}_{i - 1} + {a}_{i} ) y ( k - i ) \qquad ( 8 )$$

In the case of a three-step ahead prediction, the predicted sample is similarly formulated as follows:

$${y}_{3} ( k ) = {a}_{1} {y}_{2} ( k - 1 ) + {a}_{2} {y}_{1} ( k - 2 ) + {\sum }_{i = 3}^{P} {a}_{i} y ( k - i ) \qquad ( 9 )$$

and by replacing y₁(k−2) from (6) and y₂(k−1) from (8), the following formula is obtained:

$${y}_{3} ( k ) = ( {a}_{1}^{2} {a}_{P - 1} + {a}_{1} {a}_{P} + {a}_{2} {a}_{P - 1} ) y ( k - P - 1 ) + ( {a}_{1}^{2} {a}_{P} + {a}_{2} {a}_{P} ) y ( k - P - 2 ) + {\sum }_{i = 3}^{P} ( {a}_{1}^{2} {a}_{i - 2} + {a}_{1} {a}_{i - 1} + {a}_{2} {a}_{i - 2} + {a}_{i} ) y ( k - i ) \qquad ( 10 )$$

Generally, the j-th missing data sample may be given by the following equation:

$${y}_{j} ( k ) = {\sum }_{i = 0}^{j - 1} {a}_{i} {y}_{j - i} ( k - i ) + {\sum }_{i = j}^{P} {a}_{i} y ( k - i ) \qquad ( 11 )$$

where 2≦j≦L and a₀=0. It is assumed that P≧L, which is reasonable because the maximum tolerable number of missing data samples, L, is usually small in real time control systems. By iterative substitution of previously predicted yⱼ₋ᵢ values in (11), the following general formula may be derived:

$${y}_{j} ( k ) = {\sum }_{i = j}^{P + j - 1} {A}_{i}^{j} y ( k - i ) ; 1 \leq j \leq L \qquad ( 12 )$$

where the Aᵢ^{j} multipliers can be recursively computed by the following equations:

$$\begin{matrix}{A}_{i}^{1} = {a}_{i} ; 1 \leq i \leq P & ( 13 ) \\ {A}_{i}^{j} = \{ \begin{matrix}0 ; & i < j \\ {a}_{i} + {\sum }_{l = 1}^{j - 1} {a}_{l} {A}_{i - l}^{j - l} ; & j \leq i \leq P \\ {\sum }_{l = 1}^{j - 1} {a}_{l} {A}_{i - l}^{j - l} ; & P < i < j + P \\ 0 ; & i \geq j + P\end{matrix} & ( 14 )\end{matrix}$$

where 2≦j≦L≦P. Equation (12) shows that the proposed predictive filter is a FIR filter with the following transfer function:

$${H}_{FIR}^{j} ( {z}^{- 1} ) = {Y}_{j} ( {z}^{- 1} ) / Y ( {z}^{- 1} ) = {\sum }_{i = j}^{P + j - 1} {A}_{i}^{j} {z}^{- i} ; 1 \leq j \leq L . \qquad ( 15 )$$

In accordance with the present invention, the aᵢ weights are tuned in such a way that the resulting filter can be used to predict the missing values of any of the required number of missing data samples up to L by (6), (7), (9) or (11).

In the present tuning algorithm, aᵢ values are searched for that minimise the following error function:

$$E = \frac{1}{2} {\sum }_{j = 1}^{L} \{ {C}_{j} {\sum }_{k = 1}^{N} {[ y ( k ) - {y}_{j} ( k ) ]}^{2} \} . \qquad ( 16 )$$

where N is the total number of samples used for off-line tuning and the Cⱼ are constants selected based on the priority of the performance of the one to L-step ahead predictions, e.g. based on the expected frequency of each multi-step prediction. This prioritisation depends on the application. In most real time applications, a lower number of steps ahead in prediction has a higher priority, i.e. C₁>C₂> . . . >C_{L}. However, other priorities may be set, e.g. if it is found that samples more often go missing in sets of three, C₃ may be prioritised.

In order to optimise the error function, a steepest gradient method is utilised. In this method, the weight vector Θ=[a₁ a₂ . . . aₚ]^{T} is iteratively moved in the reverse direction of the gradient vector of the error function with respect to the weight vector. Hence, calculation of this gradient is required, which can be expressed as:

$$\begin{matrix}{∇}_{Θ} E = {[ \begin{matrix}\frac{\partial E}{\partial {a}_{1}} & \frac{\partial E}{\partial {a}_{2}} & … & \frac{\partial E}{\partial {a}_{p}}\end{matrix} ]}^{T} & ( 17 ) \\ \frac{\partial E}{\partial {a}_{j}} = {\sum }_{i = 1}^{L} \{ {C}_{i} {\sum }_{k = 1}^{N} \frac{\partial {y}_{i} ( k )}{\partial {a}_{j}} ( y ( k ) - {y}_{i} ( k ) ) \} & ( 18 )\end{matrix}$$

Equations (8), (10), and (12-14) show that direct calculation of ∂yᵢ(k)/∂aⱼ and its formulation can be complicated for i>1. Therefore, an indirect iterative calculation may be made instead, based on (6), (7), (9) and (11), as this is easier to formulate and compute. Partial differentiation of (6) with respect to aⱼ simply gives:

$$\frac{\partial {y}_{1} ( k )}{\partial {a}_{j}} = y ( k - j ) \qquad ( 19 )$$

Partial differentiation of (7) with respect to aⱼ and replacing ∂y₁/∂aⱼ from (19) gives:

$$\frac{\partial {y}_{2} ( k )}{\partial {a}_{1}} = {y}_{1} ( k - 1 ) + {a}_{1} y ( k - 2 ) \\ \frac{\partial {y}_{2} ( k )}{\partial {a}_{j > 1}} = {y}_{1} ( k - j ) + {a}_{1} y ( k - j - 1 ) \qquad ( 20 )$$

Partial differentiation of (9) with respect to aⱼ and replacing ∂y₁/∂aⱼ and ∂y₂/∂aⱼ from (19) and (20) results in:

$$\frac{\partial {y}_{3} ( k )}{\partial {a}_{1}} = {y}_{2} ( k - 1 ) + {a}_{1} {y}_{1} ( k - 2 ) + ( {a}_{1}^{2} + {a}_{2} ) y ( k - 3 ) \\ \frac{\partial {y}_{3} ( k )}{\partial {a}_{2}} = {y}_{1} ( k - 2 ) + {a}_{1} y ( k - 3 ) + ( {a}_{1}^{2} + {a}_{2} ) y ( k - 4 ) \\ \frac{\partial {y}_{3} ( k )}{\partial {a}_{j > 2}} = y ( k - j ) + {a}_{1} y ( k - j - 1 ) \qquad ( 21 )$$

By a similar approach, the following general formula for ∂yᵢ(k)/∂aⱼ can be achieved:

$$\partial {y}_{i} ( k ) / \partial {a}_{j} = \{ \begin{matrix}{\sum }_{l = 0}^{i - j - 1} {B}_{l} {y}_{i - j - l} ( k - l - j ) + {\sum }_{l = i - j}^{i - 1} {B}_{l} y ( k - l - j ) ; & j < i \\ {\sum }_{l = 0}^{i - 1} {B}_{l} y ( k - l - j ) ; & j \geq i\end{matrix} \qquad ( 22 )$$

where 1≦j≦P, 2≦i≦L and the multipliers Bₗ can be recursively calculated by the following equations:

$${B}_{l} = \{ \begin{matrix}1 ; & l = 0 \\ {\sum }_{i = 1}^{min ( l , P )} {a}_{i} {B}_{l - i} ; & l > 0\end{matrix} \qquad ( 23 )$$

The gradient vector in (17) and (18) can be iteratively calculated by (19-23) and then applied to weight adaptation by the following rule:
ΔΘ(l)=−η∇_{Θ}E(l)+αΔΘ(l−1) (24)

where l is the iteration number of the search process over the whole ensemble of N samples, −η∇_{Θ}E(l) is the steepest gradient term and αΔ⊖(l−1) is a momentum term, added to avoid local minima.

In the search algorithm, the filter weight vector may be initialised to [1 0 0 . . . 0]^{T} so that the filter corresponds to a zero order hold system, which is a simple and general predictor. The weights are tuned off-line by (17-24) and then used for missing data handling in the real-time application.

If for any reason, dynamic characteristics of the sensor signal change, the filter weights can be adaptively tuned by using the equations (17-24) in real-time time i.e. the summations in (18) are ignored and l in (24) is replaced with the signal sampling time k.

Although discussed above mainly in respect of vehicle management systems, the present invention is applicable to control systems in general, and a generic control system is shown in block form in FIG. 2.

Thus, a processor 20 may receive input data samples 22 from a sensor, and may control an actuator 24 or take a suitable action accordingly. The processor 20 may include associated memories 26 and 28 which store the previous P data samples y(k−i) or predicted data y′(k−i) (1≦i≦P), and the filter weights {a₁, . . . , a_{P}].

Thus, when the processor 20 determines that data 22 has not been received in a timely fashion, it runs a prediction algorithm using a filter as discussed above, in which the same filter weights {a₁, . . . , a_{P}} can be used for any number of consecutive missing data, and in which the filter weights have been tuned for the particular sensor system, e.g. sensor and sensed feature/object, from which the data is received.

The processor 20 may run a weight tuning process as shown in the flowchart of FIG. 3. It may do this when offline and in a training mode. Alternatively, the procedure may be run on an external apparatus that may plug into the processor system or that may simulate the sensor signal dynamics, e.g. obtain data from an identical sensor system.

Thus, the processor 20 may receive known training data in step S10, and in step S20 may set the filter weights {a₁, . . . , a_{P}] to a simple zero order hold filter at [1 0 0 . . . 0] or, if the sensor has previously been tuned, may use the currently stored weight settings. The processor may then determine the value of an error function E, e.g. as discussed above, between the actual data values and the predicted values for the various multi-step ahead predictions at step S30. The processor 20 will then determine whether the weights are optimised at step S40, e.g. by determining that the error function has not changed significantly over a set number of iterations or by determining if the error has reached below a specific threshold. If not optimised, the processor will modify the weights aᵢ at step S50 and re-determine the error function at step S30. This iteration is continued until the error function E is determined to be optimised, at which point, at step S60, the weights as currently stored are set as the filter weights for real time use at step S60.

The other control systems may include for example systems in which one or more sensors play a vital role in the system, and systems in which missing sensor data may cause system failure and/or may raise safety critical issues. This would apply for example to brake systems in general. Other examples could include aerospace control systems, military control systems, satellite motion control systems, and space robotic control systems, especially those that are mainly controlled autonomously by their own sensors. It could for example relate to systems in which the sensor data stream is GPS data. It is particularly useful in applications that have restrictive amounts of memory and/or processor time available.

It is to be understood that various alterations, additions and/or modifications may be made to the parts previously described without departing from the ambit of the present invention, and that, in the light of the above teachings, the present invention may be implemented in a variety of manners in software, firmware and/or hardware, as would be understood by the skilled person.

1. A control system having a processing unit and a sensor, the system including a multi-step ahead predictive filter for the sensor data, the filter 5 predicting a data sample based on a weighted function of prior data samples, wherein the filter uses a single set of weights for weighting the prior data samples, irrespective of the number of missing data samples for which the prediction is required, and wherein the set of weights has been previously determined based on the characteristics of the sensor signal.

2. The system of claim 1, wherein the weights are determined by optimising an error function between a known output signal for the sensor and a predicted output signal

3. The system of claim 2, wherein said optimisation process is based on an error function that takes the form of a sum of terms, one term for each possible step ahead prediction, each term being a sum of errors over all data samples between the actual data values and the predicted values for that term's step ahead.

4. The system of claim 3, wherein the error function is weighted to prioritise one of more of the multi-step ahead predictions.

5. The system of claim 3, wherein the lower the number of missing steps for a prediction, the higher the priority weighting.

6. The system of claim 2, wherein said optimisation process is based on an iterative process.

7. The system of claim 6, wherein the iteration process is based on a steepest gradient descent method.

8. The system of claim 1, wherein the control system is a vehicle management system.

9. The system of claim 1, wherein the control system is a vehicle brake system.

10. The system of claim 1, wherein the sensor is a wheel speed sensor or a foot pedal sensor, e.g. brake pedal sensor.

11. The system of claim 1, wherein the weights are updateable.

12. A control system including a control unit and a sensor, wherein the system includes a predictive filter for determining missing sensor data, the filter taking the form:
$$\hat{y} ( k ) = {\sum }_{i = 1}^{ρ} {a}_{i} {y}^{′} ( k - i ) \qquad ( 4 )$$
where y′(k−i) is either equal to a previous data sample y(k−i) or a previously predicted sample y(k−i), and wherein the aᵢ are determined based on characteristics of the sensor signal, such that the same set of aᵢ are used for all missing data predictions.

13. The control system of claim 12, wherein the weights aᵢ are determined based on the optimisation of an error function of the form:
$$E = {\sum }_{j = 1}^{L} {C}_{j} \{ {\sum }_{k = 1}^{N} ρ ( {y}_{j} ( k ) - y ( k ) ) \}$$
where L is the maximum number of consecutive missing data samples to be predicted, Cⱼ are weights to prioritise one more of the number of consecutive 25 missing data samples, and where p(x) is any function with the properties: 1) p(O)=O, 2) for all x p(x)≧0, and 3) if |x₁|>|x₂| then p(|x₁|>p|x₂|.

14. The control system of claim 12, wherein the weights aᵢ are determined based on the optimisation of an error function of the form:
$$E = \frac{1}{2} {\sum }_{j = 1}^{L} \{ {C}_{j} {\sum }_{k = 1}^{N} {[ y ( k ) - {y}_{j} ( k ) ]}^{2} \} ,$$
where L is the maximum number of consecutive missing data samples to be predicted, and Cⱼ are weights to prioritise one more of the number of consecutive missing data samples.

15. A method of controlling a sensor system, including the step of predicting sensor data, the method including the step of predicting a data sample based on a weighted function of prior data samples, wherein a single set of weights are used to weight the prediction function for predictions for a plurality of different numbers of consecutive missing data samples, and wherein the set of weights has been previously determined based on the characteristics of the sensor output.

16. A method of determining the weights of a multi-step ahead predictive filter for a sensor, the method including the step of determining a single set of weights for a plurality of the predictions, wherein the set of weights are determined based on the characteristics of the output of the sensor.

17. Computer software for controlling a system based on data from a sensor, the software including:
a component for detecting that sensor data is unavailable; and
a component for estimating the sensor data when unavailable, the sensor data being estimated based on a weighted function of prior data samples, wherein a single set of weights are used to weigh the prior data samples for all estimates, and wherein the weights are based on the characteristics of the sensor output.

18. A vehicle control system including a control unit and a sensor, the system including a multi-step ahead predictive filter for the sensor data, the filter predicting a data sample based on a weighted function of prior data samples, wherein the filter uses a single set of weights for weighting the prior data samples, irrespective of the number of missing data samples for which the prediction is required, and wherein the set of weights has been previously determined based on the characteristics of the sensor signal.
